(19) United States
(12) Patent Application Publication
(10) Pub. No.: US 2005/0083463 A1
(43) Pub. Date: Apr. 21, 2005

(54) Retardation film and process for producing the same

(75) Inventors: Takeya Sakai, Nagoya-shi (JP); Masao Uetsuki, Kurashiki-shi (JP); Nobuhiro Kawatsuki, Himeji-shi (JP)

Correspondence Address: SUGHRUE MION, PLLC, 2100 PENNSYLVANIA AVENUE, N.W., SUITE 800, WASHINGTON, DC, 20037, US

(73) Assignee: HAYASHI TELEMPU CO., LTD

(21) Appl. No.: 10/686,672

(22) Filed: Oct. 17, 2003

(51) Int. Cl. G02F 1/1335

(52) U.S. Cl. 349/118

(57) ABSTRACT

A retardation film mainly used in a liquid crystal display and a process for producing the retardation film are provided. By using the retardation film having a birefringence, a coloring phenomenon and gray scale inversion can be reduced and viewing angle characteristics of a TN liquid crystal display can be improved.

### BACKGROUND OF THE INVENTION

1. Field of the Invention

The present invention relates to a retardation film used to improve viewing angle characteristics of a liquid crystal display, and to a process for producing the retardation film.

2. Description of the Related Art

Retardation films are films passing linear polarized light components oscillating in major axis directions orthogonal to each other and having birefringence providing a given retardation between these two components. Such retardation films are also utilized in the fields of liquid crystal displays. Particularly retardation films having liquid crystal materials having negative birefringences and slant-oriented or bent-oriented are utilized as optical compensation films that are effective for enlarging an angle of visibility of the liquid crystal display. Although such a retardation film can ensure an effect of greatly enlarging the angle of visibility, the sufficient optical compensation effect cannot be often attained, depending on a direction in which a user sees the liquid crystal display. For this reason, at present, the liquid crystal display with the retardation film cannot replace a cathode-ray tube (CRT) display.

Further, as described in JP A-7-287119, JP A-7-287120, and JP A-10-278123, such a retardation film is constituted so that a liquid crystal material, such as a discotic liquid crystal, that is a negative refractive index ellipsoid is arranged on an alignment layer prepared by such a method as rubbing, SiO slanting deposition or light irradiation. However, the discotic liquid crystal consists of a structure such as a triphenylene skeleton, and when the discotic liquid crystal is installed in the liquid crystal display, yellowish display appears at a large angle of view in a lateral direction due to the great wavelength dispersion, which disadvantageously degrades image quality of the liquid crystal display. Further, the process using such an alignment layer requires a step of coating and drying an alignment material, a step of aligning an alignment layer, a step of coating and drying a liquid crystal to be aligned, a step of aligning the liquid crystal, and the like. Therefore, the process disadvantageously involves complicated steps.

Methods for overcoming the disadvantage of the complicated steps include a method involving developing a retardation by irradiating a light. As for this method, a negative uniaxial retardation film, having its optical axis inclined, constituted so that a light is irradiated onto a polymer sheet including a photoisomerized azobenzene is proposed in JP A-7-168020 and JP A-7-207037. However, since this film uses the photoisomerization of azobenzene, it is considered to be impractical in terms of heat resistance, optical stability and the like. Further, a method for irradiating with a light a liquid crystal alignment material substituted with an azobenzene derivative and developing dichromatic photoisomerization is proposed in JP A-11-160708. However, in this publication, only the development of birefringence by irradiation with light is confirmed and no mention about practicability is made. Further, disclosed in JP A-11-18372 is a retardation film prepared by irradiating with a light a liquid crystal material film having photoreactive substituents and rendering a leading phase axis (fast axis) or a lagging phase axis (slow axis) in a sheet to be a tilt axis such that dependence of a retardation value on a tilt angle is asymmetric to the normal. However, only by setting the dependence of the retardation value on the tilt angle asymmetric to the normal with either the leading phase axis or lagging phase axis regarded as the tilt angle, yellowish display appears at a large angle of view in the lateral direction when the retardation film is installed in a liquid crystal display, degrading image quality. Therefore, this retardation film cannot ensure a sufficient optical compensation effect.

### SUMMARY OF THE INVENTION

It is an object of the present invention to provide a retardation film capable of improving viewing angle characteristics of a TN liquid crystal display, i.e., capable of reducing a coloring phenomenon and gray scale inversion and to provide an industrial process for producing the retardation film.

As shown in FIG. 1, a first retardation film having a birefringence according to the present invention has primary refractive indexes nx′ (in a direction of an axis 11a), ny′ (in a direction of an axis 11b) and nz′ (in a direction of an axis 11c) of a biaxial index ellipsoid 11 in directions in which a biaxial index ellipsoid having primary refractive indexes nx, ny, and nz in the directions of X and Y axes parallel to a film surface and a Z axis normal to the film surface is rotated at an angle θ1° about the X axis as an axis of rotation and at an angle θ2° about the Y axis as an axis of rotation.

Since the first retardation film having the birefringence according to the present invention has primary refractive indexes nx′, ny′, and nz′ of the biaxial index ellipsoid in directions in which the biaxial index ellipsoid having primary refractive indexes nx, ny, and nz in X, Y, and Z axis directions is rotated at the angle θ01° about the X axis that is set as the axis of rotation and at the angle θ2° about the Y axis that is set as the axis of rotation, it is possible to provide the retardation film effective for reducing a coloring phenomenon and gray scale inversion and for enlarging a viewing angle of a liquid crystal display.

By attaching at least one retardation film between a liquid crystal cell and a polarizing plate in a TN liquid crystal display which consists of the liquid crystal cell having a TN liquid crystal put between two electrode substrates and two polarizing plates arranged on both sides of the liquid crystal cell, respectively, it is possible to reduce the coloring phenomenon and the gray scale inversion and improve the viewing angle characteristics of the TN liquid crystal display.

It is preferable that the first retardation film is produced by steps of forming a film from a photosensitive material; and irradiating a light from a direction inclined with respect to the film surface or with or without heating and cooling the film.

As shown in FIG. 5, a second retardation film according to the present invention has a birefringence bearing a combination of a first index ellipsoid having primary refractive indexes nx in an X axis direction, ny in a Y axis direction and nz in a Z axis direction, where the primary refractive indexes nx, ny, and nz satisfy a relationship of nx>ny≧nz, and a second index ellipsoid, having primary refractive indexes nx′, ny′, nz′, obtained by rotating the first index ellipsoid at an angle of θ3° about the Y axis as an axis of rotation and at an angle of θ4° about the Z axis as the axis of rotation, where the primary refractive indexes nx′, ny′, and nz′ satisfy a relationship of nx′>ny′≧nz′, if a plane formed by the X and Y axes represents the film surface and the Z axis conforms a direction of the film thickness.

Since the second retardation film according to the present invention has the birefringence bearing a combination of the first index ellipsoid having primary refractive indexes nx in an X axis direction, ny in a Y axis direction and nz in a Z axis direction, where the primary refractive indexes nx, ny, and nz satisfy a relationship of nx>ny≧nz, and the second index ellipsoid having primary refractive indexes nx′, ny′, nz′, obtained by rotating the first index ellipsoid at an angle of θ3° about the Y axis as an axis of rotation and at an angle of θ4° about the Z axis as the axis of rotation, where the primary refractive indexes nx′, ny′, and nz′ satisfy a relationship of nx′>ny′≧nz′, if a plane formed by the X and Y axes represents the film surface and the Z axis conforms a direction of the film thickness, it is possible to provide the retardation film effective for reducing a coloring phenomenon and gray scale inversion and for enlarging a viewing angle of a liquid crystal display.

By attaching at least one retardation film between a liquid crystal cell and a polarizing plate in a TN liquid crystal display which consists of the liquid crystal cell having a TN liquid crystal put between two electrode substrates and two polarizing plates arranged on both sides of the liquid crystal cell, respectively, it is possible to reduce the coloring phenomenon and the gray scale inversion and improve the viewing angle characteristics of the TN liquid crystal display.

It is preferable that the second retardation film is produced by steps of forming a film from a photosensitive material; irradiating a light from a direction inclined with respect to the film surface; and heating and cooling the film if necessary.

Further, it is preferable that, in the process for producing the second retardation film, the light irradiated from the direction inclined with respect to the film surface is a light in which a perfectly polarized light component and a non-polarized light component are mixed together, and that a direction of electric field oscillation of the perfectly polarized light component is non-parallel and non-orthogonal to a plane of incidence of the irradiated light.

Since the retardation film according to the present invention exhibits different birefringences according to observation directions, it is assumed herein, in particular, that a direction of a lagging phase axis of a birefringence observed from a normal direction of a film surface is a reference axis and that a direction of the reference axis observed from the normal direction of the film surface is a direction of 0° with respect to rotation about the normal direction of the film surface that is set as a central axis.

### BRIEF DESCRIPTION OF THE DRAWINGS

These present invention will be clearly understood from the following preferred descriptions of the examples with reference to the accompanying drawings. However, the examples and the drawings are given only for illustrative and descriptive purposes and should not be used to define the scope of the invention. The scope of the invention is specified by the accompanying claims. In the accompanying drawings, same reference numerals are used to denote same parts throughout the several views.

In the drawings,

FIG. 1 is an explanatory diagram for birefringence of a first retardation film according to the present invention;

FIG. 2 illustrates a result of measuring a birefringence of the first retardation film in Example 1;

FIG. 3 illustrates an example of an optical system when the first retardation film is attached to a liquid crystal display;

FIGS. 4A to 4F illustrate examples of calculations of optical compensation results by transmitted light simulation using a 4×4 matrix method when the retardation film is attached to the liquid crystal display and when the retardation film is not attached to the liquid crystal display;

FIG. 5 is an explanatory diagram for a birefringence of a second retardation film according to the present invention;

FIG. 6 illustrates a result of measuring the birefringence of the second retardation film in Example 2;

FIG. 7 illustrates an example of an optical system when the second retardation film is attached to a liquid crystal display; and

FIGS. 8A to 8F illustrate examples of calculations of optical compensation results by transmitted light simulation using the 4×4 matrix method when the retardation film is attached to the liquid crystal display and when the retardation film is not attached to the liquid crystal display.

### DETAILED DESCRIPTION OF THE INVENTION

A first retardation film according to the present invention will be described herein in detail.

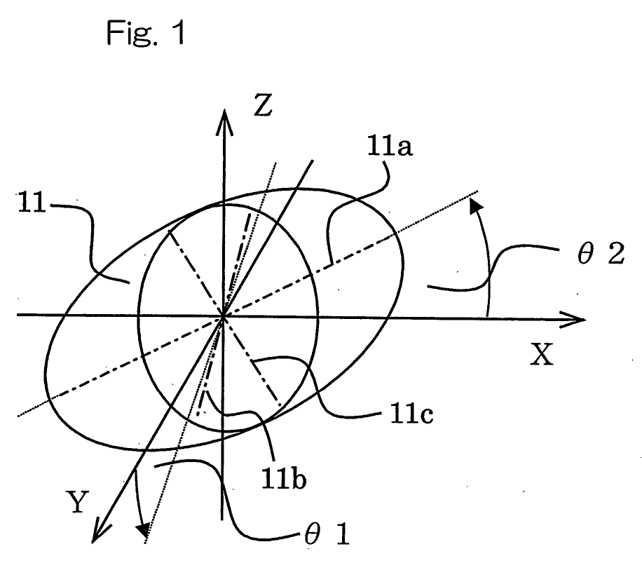

As shown in FIG. 1, the first retardation film having a birefringence according to the present invention is characterized in that, when it is assumed that there is a biaxial index ellipsoid having primary refractive indexes nx, ny, and nz in X, Y, and Z axis directions in a coordinate system that consists of X and Y axes parallel to a film surface and a Z axis normal to the film surface, the retardation film has primary refractive indexes nx′ (in a direction of an axis 11a), ny′ (in a direction of an axis 11b) and nz′ (in a direction of an axis 11c) of a biaxial index ellipsoid in a direction in which the biaxial index ellipsoid, having the primary refractive indexes nx, ny, nz, is rotated at an arbitrary rotational angle θ1° about the X axis as an axis of rotation and at an arbitrary rotational angle θ2° about the Y axis as an axis of rotation. A retardation film in Example 1 is typical of the first retardation film.

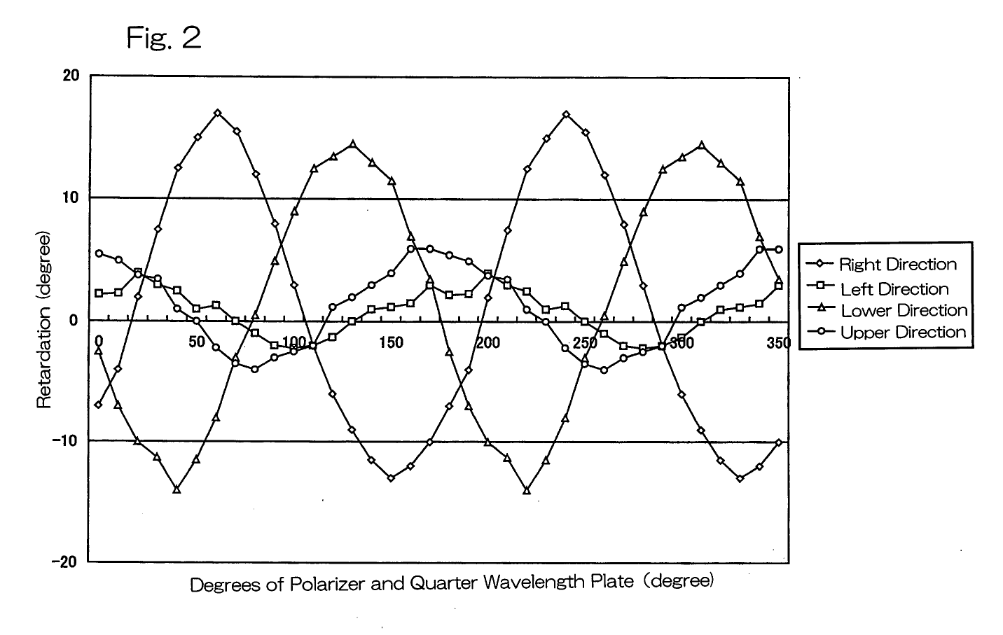

FIG. 2 illustrates a result of measuring a birefringence of the first retardation film using a Senarmont method. An azimuth angle is assumed 0° when a polarizer arranged to have a transmission angle of 45° with respect to a horizontal plane is arranged to confront the film (an incident angle of 0°) and a direction of a lagging phase axis in the film plane is orthogonal to a direction of angle of the transmission axis of the polarizer. Accordingly, a direction in which the film is rotated by 55° about the normal axis of the horizontal plane is set as a right direction and a direction in which the film is rotated by −55° about the normal axis of the horizontal plane, contrary to the right direction, is set as a left direction. A direction in which the azimuth angle is rotated by 90° and the film is rotated by 55° about the normal axis of the horizontal plane is set as a lower direction and a direction in which the film is rotated by −55° about the normal axis of the horizontal plane is set as an upper direction, contrary to the lower direction. The polarizer and a quarter wavelength plate are kept in phase with each other and rotated by 360° in the respective directions and retardations are measured (note that the respective directions are assumed as directions suited when the retardation film in this example is combined with and attached to the liquid crystal display). This measurement makes it possible to attain a knowledge about birefringence of the retardation film such as an inclination direction of the axis in which a projection profile of the refractive index of the retardation film has a largest size in each of the lateral and vertical directions, and a magnitude of the retardation.

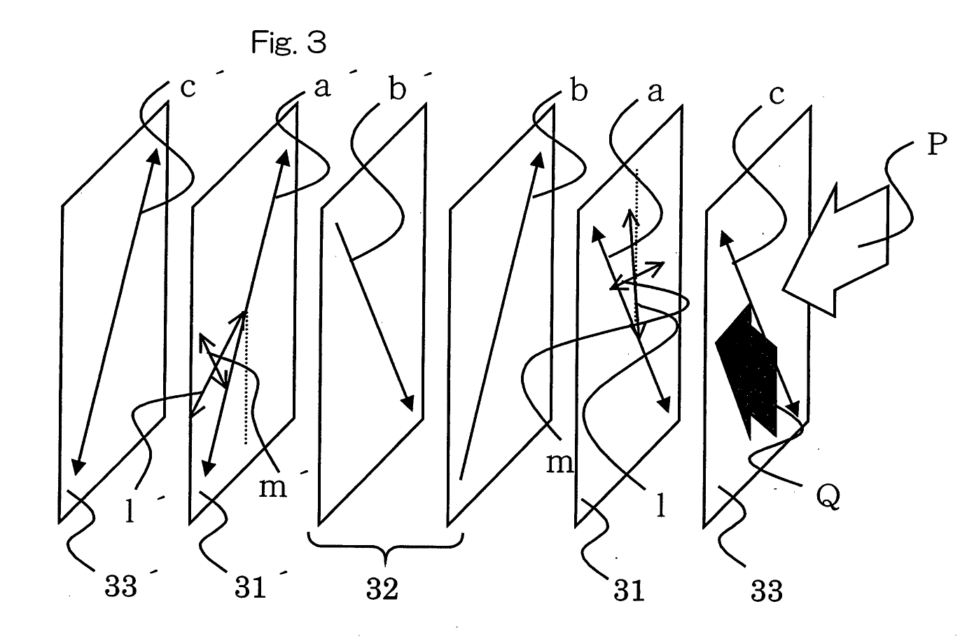

Based on this knowledge, the retardation film in this example and a film having a negative birefringence may be attached together to the liquid crystal display in optical arrangement shown in FIG. 3.

In FIG. 3, reference numerals 31 and 31′denote the first retardation films according to the present invention, symbols a and a′ denote directions of the lagging phase axis when the respective retardation films are viewed from the front, reference numerals 1 and 1′ denote directions of the primary refractive index nx′ of the index ellipsoid 11 shown in FIG. 1, and symbols m and m′ denote a direction of the primary refractive index ny′. Reference numeral 32 denotes a liquid crystal cell, and symbols b and b′ denote pre-tilt directions of the respective liquid crystal cells. Reference numerals 33 and 33′ denote polarizing plates, and symbols c and c′ denote light transmission axis directions of the respective polarizing plates 33 and 33′. If the retardation films are attached in this manner, it is confirmed that wide viewing angle characteristic can be developed without the appearance of a yellowish color in the lateral directions (P direction or Q direction) of the liquid crystal display.

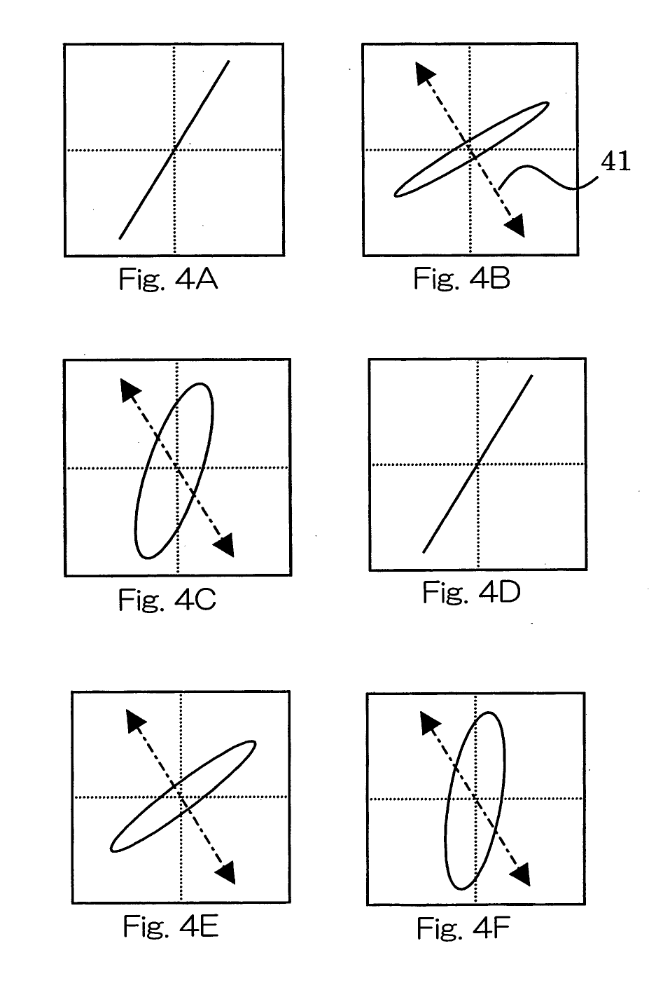

Further, it is confirmed from FIGS. 4A to 4F that a good optical compensation effect can be attained if the first retardation films according to the present invention are attached to the liquid crystal display in a transmission light simulation using 4×4 matrix method. Namely, 4A to 4F illustrate an simulation of a transmission light when the transmission axes of the polarizing plates are orthogonal to the display screen at 45° and a black color is displayed in the liquid crystal display wherein one each of the first retardation films according to the present invention are attached to a rear side (a back light source side) and a front side (a display surface side) of the display.

FIGS. 4A and 4D illustrate polarized states of a light transmitted by a rear side polarizing plate when the liquid crystal display is viewed from an angle of 55° in the right direction and an angle of 55° in the left direction, respectively. FIGS. 4B and 4E illustrate polarized states of a light incident on the front side polarizing plates when the retardation film according to the present invention and the negative birefringence film are attached to the liquid crystal display in the optical arrangement shown in FIG. 3, respectively (in FIG. 4B, reference numeral 41 denotes the transmission axis of the front side polarizing plate).

As can be seen from FIGS. 4A, 4B, 4D and 4E, the simulation demonstrates that since the light transmitted through the liquid crystal cells from the rear surface of the liquid crystal display is orthogonal to the transmission axis direction of the front side polarizing plate in a state in which the light is relatively close to a linear polarized light, black color display is maintained, and that the good optical compensation effect can be obtained.

FIGS. 4C and 4F illustrate polarized states of the light incident on the front side polarizing plate when the retardation film and the negative birefringence film are not attached to the liquid crystal display. As can be seen from FIGS. 4C and 4F, when the films are not attached to the liquid crystal display, the polarized state is largely disturbed, the light direction is not perpendicular to the transmission axis direction of the front side polarizing plate, and the black color display cannot be maintained.

To produce the retardation film according to the present invention, a material that exhibits a birefringence when it is irradiated with a light, heated, and cooled as described in JP A-11-189665 and Japanese Patent Application No. 2000-400356 both of which were filed by the inventor of the present application can be used. For example, a polymer having a side chain containing a structure comprising a combination of a substituent such as biphenyl, terphenyl, phenyl benzonate or azobenzene, which is frequently used as the mesogene compound of a liquid crystal polymer, and a photosensitive group such as a cinnamoyl group, a chalcone group, a cinnamylidene group, β-(2-furyl)acryloyl group (or its derivative), and having a main chain comprising a structure such as a hydrocarbon, acrylate, methacrylate, maleimide or N-phenylmaleimide and siloxane. The polymer may be either a homopolymer comprising the same repeat units or a copolymer of units having side chains with different structures, or a unit having a side chain containing no photosensitive group may be copolymerized. The low molecular compound to be mixed is, for example, a crystalline or liquid crystal compound having a substituent such as biphenyl, terphenyl, phenyl beonzonate or azobenzene which is frequently used as the mesogene compound. When the low molecular compound is mixed, not only a single compound but also plural types of compounds can be mixed. Further, an orientation assistant for improving an orientation property without deteriorating the liquid-crystallinity or a cross linking agent for improving heat resistance may be added, or a monomer that does not have a liquid crystallinity may be copolymerized with a photosensitive polymer without deteriorating the liquid crystallinity.

Such a material is coated on a transparent substrate to produce a film. Namely, the substrate is irradiated with two linear polarized lights having electric field oscillation planes orthogonal to each other at respective desired angles, heated and cooled to produce the film. In this case, molecules in the film are to be oriented in directions of electric field oscillation of the two linear polarized lights. Therefore, it is possible to produce the retardation film having a birefringence according to the present invention characterized by having primary refractive indexes nx′, ny′, and nz′ of a biaxial index ellipsoid which is obtained by rotating a biaxial index ellipsoid, having primary refractive indexes nx, ny, and nz in X, Y, and Z axis directions, in a direction at the angle θ1° about the X axis that is set as an axis of rotation and at the angle θ2° about the Y axis that is set as an axis of rotation. It is confirmed by fitting with a result of an optical simulation conducted to a layer medium having a birefringence using a Muller method that the angle dependency of the retardation of the retardation film thus produced according to the Senarmont method well coincides with the dependency of the biaxial index ellipsoid having primary refractive indexes nx′, ny′, and nz′ obtained by rotating the biaxial index ellipsoid, having primary refractive indexes nx, ny, and nz in X, Y, and Z axis directions, in the direction at the angle θ1° about the X axis that is set as an axis of rotation and at the angle θ2° about the Y axis that is set as an axis of rotation.

Now, the birefringence of the retardation film is measured as the tilt direction of the axis having the highest refractive index in the vertical and horizontal directions and the magnitude of the retardation by the measurement method shown in FIG. 2. The birefringence needs to be adjusted according to optical characteristics determined by a twist direction, a cell thickness, a tilt angle, a liquid crystal type, and the like of the liquid crystal display to which the film is attached. The tilt direction of the axis having the highest refractive index when viewed from the right direction in the measurement result shown in FIG. 2 is preferably about 45±15° with respect to a horizontal direction from this observation direction, more preferably 45±10° for many TN liquid crystal displays. Further, the retardation in this observation direction is preferably about 50 to 250 nm. It is also preferable that the axis having the highest refractive index when observed from the upper direction has a tilt smaller than that in the direction of the reference axis observed from the upper direction and that the axis having the highest refractive index when observed from the lower direction has a tilt larger than that in the direction of the reference axis observed from the lower direction so as to enlarge the viewing angle in the upper and lower directions. To adjust the birefringence of the retardation film, it is effective to change a film thickness and an irradiation quantity, a degree of polarization, and an irradiation direction of the irradiated light. The retardation film can be used in combination with a negative birefringence film, a uniaxial oriented film, and a biaxial oriented film.

It is noted, however, that the process for producing the retardation film according to the present invention is not limited to the process including light irradiation onto the material that is caused to exhibit a birefringence by light irradiation, heating and cooling. As long as the resultant retardation film exhibits the birefringence as stated above, the film may be produced by any arbitrary process such as a process including slicing a biaxial oriented transparent resin rod at a desired inclined angle, a conventional different circumferential speed stretching process, a process including orienting liquid crystal molecules on an alignment layer, a process including deposition of an inorganic substance, or such processes combined thereof.

Synthetic methods relating to raw material compounds for the photosensitive polymer and the low molecular compound of the first retardation film used in Example 1 of the present invention will be shown below.

Monomer (1)

4,4′-biphenyldiol and 2-chloroethanol were heated in alkaline or basic conditions to synthesize 4-hydroxy-4′-hydroxyethoxybiphenyl. 1,6-dibromohexane was reacted with the product in alkaline conditions to synthesize 4-(6-bromohexyloxy)-4′-hydroxyethoxybiphenyl. Next, lithium methacrylate was reacted with the resulting product to synthesize 4-hydroxyethoxy-4′-(6-methacryloyloxyhexyloxy) biphenyl. Finally, cinnamoyl chloride was added to the resulting product in basic or alkaline condition to synthesize a monomer (1) shown by the formula 1.

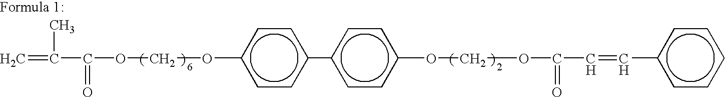

Polymer (1)

The monomer (1) was dissolved in tetrahydrofuran, to which AIBN (azobisisobutyronitrile) was added as a reaction initiator to polymerize, thereby obtaining a photosensitive polymer (1). This polymer (1) exhibited liquid-crystallinity in a temperature range from 47 to 75° C.

Low Molecular Compound (1)

4,4′-biphenyldiol was reacted with 6-bromohexanol in alkaline conditions to synthesize 4,4′-bis(6-bromohexyloxy)biphenyl. Next, cinnamoyl chloride was added to and reacted with the product in basic conditions and the resulting product was purified in a column chromatography to synthesize a low molecular compound (1) shown by the formula 2.

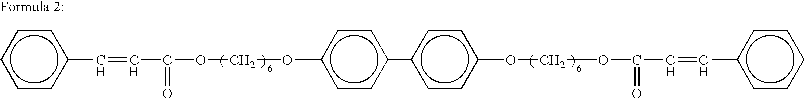

In Example 1, the first retardation film according to the present invention was produced.

### EXAMPLE 1

4.2 wt % of the polymer (1) and 0.8 wt % of the low molecular compound (1) were dissolved in dichloroethane and the mixed solution was coated on a glass substrate (support) in a thickness of about 1 μm. The substrate was inclined at an angle of 60 degrees with respect to the horizontal plane and the substrate was arranged so that a coated surface becomes an irradiated surface. The substrate was irradiated with a linear polarized ultraviolet ray at an intensity of 100 mJ/cm² so that the direction of the electric field oscillation of the ultraviolet ray is at 45° with respect to the inclined axis of the substrate. Next, the substrate was irradiated with the linear polarized ultraviolet ray at an intensity of 10 mJ/cm² so that the direction of the electric field oscillation of the ultraviolet ray is at −45° with respect to the inclined axis of the substrate. Further, the substrate was turned upside down and similarly irradiated. Next, the resultant substrate was heated to 100° C. and then cooled to room temperature.

After polarizing plates of a liquid crystal color television EV-510 manufactured by Casio Computer Co., Ltd. were peeled off, two of retardation films thus obtained were applied to a liquid crystal cell such that the both were disposed on upper and lower sides of the liquid crystal cell, respectively. Next, a polarizing plate (HEG1425DU, manufactured by Nitto Denko Corporation) was applied to each of the upper and lower sides. The axis of each optical element was arranged as shown in FIG. 3. When the liquid crystal color television having such a structure was driven, no yellowish color was generated in the lateral direction and the viewing angle characteristics were greatly improved. In addition, the viewing angle enlargement effect was recognized in the vertical direction.

### COMPARATIVE EXAMPLE 1

Similarly to Example 1, 4.2 wt % of the polymer (1) and 0.8 wt % of the low molecular compound (1) were dissolved in dichloroethane and the mixed solution was coated on a glass substrate (support) in a thickness of about 1 μm. The substrate was inclined at an angle of 60 degrees with respect to the horizontal plane and the substrate was arranged so that a coated surface becomes an irradiated surface. The substrate was irradiated with a linear polarized ultraviolet ray at an intensity of 100 mJ/cm² so that the direction of the electric field oscillation of the ultraviolet ray is in parallel to the inclined axis of the substrate. Next, the substrate was irradiated with the linear polarized ultraviolet ray at an intensity of 10 mJ/cm² so that the direction of the electric field oscillation of the ultraviolet ray is perpendicular to the inclined axis of the substrate. Further, the substrate was turned upside down and similarly irradiated. Next, the resultant substrate was heated to 100° C. and then cooled to room temperature. A retardation film wherein an inclined biaxial ellipsoid, obtained by rotating a biaxial ellipsoid only about the X axis thereof as an axis of rotation, was obtained and the inclined angle dependency of the retardation value of the film with a lagging phase axis set as an inclined axis was asymmetric to the normal direction was produced. After polarizing plates of the liquid crystal color television EV-510 manufactured by Casio Computer Co., Ltd. were peeled off, two of these retardation films were applied to a liquid crystal cell such that the both were disposed on upper and lower sides of the liquid crystal cell, respectively. Next, the polarizing plate (HEG1425DU, manufactured by Nitto Denko Corporation) was applied to each of the upper and lower sides.

When the liquid crystal color television having such a structure was driven, a yellowish color was strongly generated in the lateral direction, i.e., the image degradation occurred.

### COMPARATIVE EXAMPLE 2

Similarly to Example 1, after polarizing plates of the liquid crystal color television EV-510 manufactured by Casio Computer Co., Ltd. were peeled off, two of commercially available optical compensation films having a discotic liquid crystal bent-oriented were applied to a liquid crystal cell such that the both were disposed on upper and lower sides of the liquid crystal cell, respectively. Next, the polarizing plate (HEG1425DU, manufactured by Nitto Denko Corporation) was applied to each of the upper and lower sides.

When the liquid crystal color television having such a structure was driven, a yellowish color was strongly generated in the lateral direction, i.e., the image degradation occurred.

Example 1 demonstrates that it is possible to obtain an optical compensation sheet without generating a yellowish color even in the lateral direction when the retardation film is attached to the liquid crystal display, by using the retardation film characterized by a birefringence bearing a biaxial index ellipsoid having primary refractive indexes nx′, ny′, and nz′ obtained by rotating a biaxial index ellipsoid, having primary refractive indexes nx, ny, and nz in X, Y, and Z axis directions, in a direction at the angle θ1° about the X axis that is set as an axis of rotation and at the angle θ2° about the Y axis that is set as an axis of rotation.

The second retardation film according to the present invention will next be described.

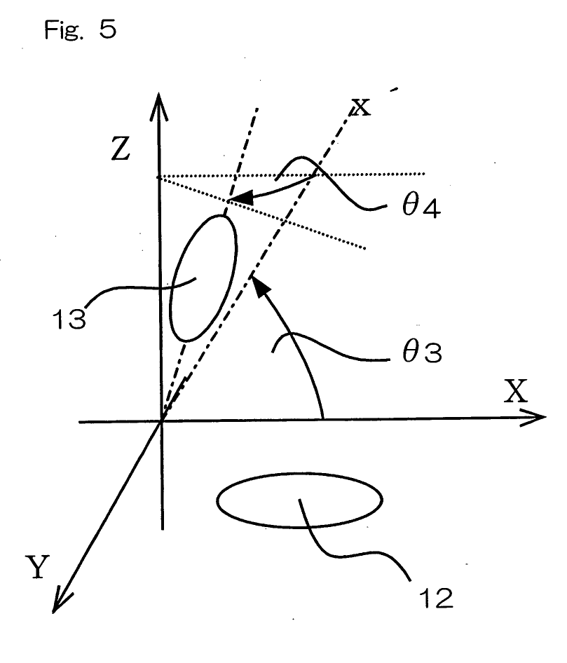

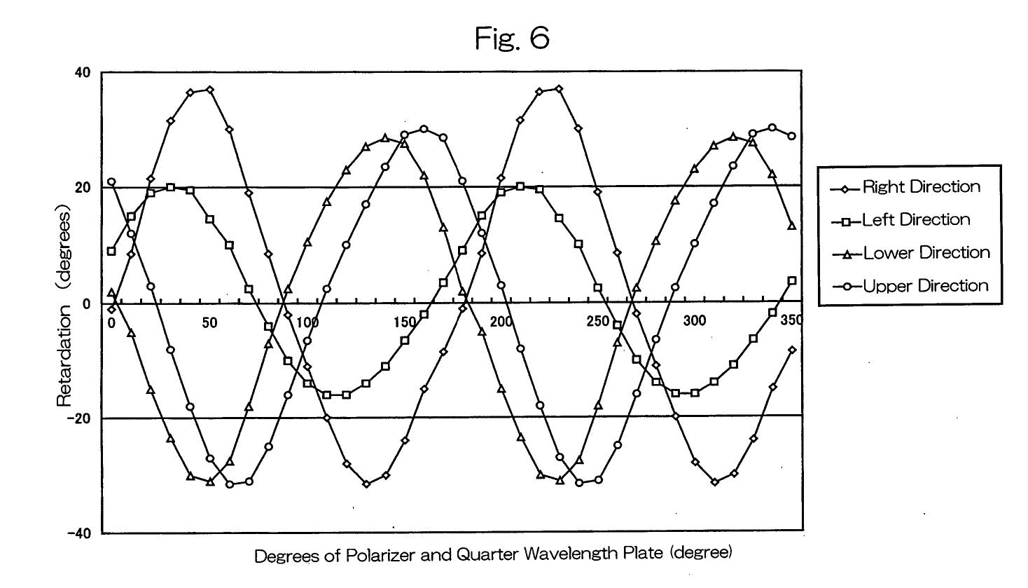

As shown in FIG. 5, the birefringence of the second retardation film according to the present invention is obtained by a combination of a first index ellipsoid 12 having the primary refractive indexes nx in the X axis direction, ny in the Y axis direction and nz in the Z axis direction (where the primary refractive indexes nx, ny, and nz satisfy a relationship of nx>ny≧nz) and a second index ellipsoid 13 having primary refractive indexes nx′, ny′, and nz′ in directions in which the first index ellipsoid is rotated at an angle of θ3° about the Y axis as the axis of rotation and at an angle of θ4° about the Z axis as the axis of rotation (where the primary refractive indexes nx′, ny′, and nz′ satisfy a relationship of nx′>ny′≧nz′). A retardation film in Example 2 is typical of the second retardation film of the present invention. FIG. 6 illustrates a result of measuring the birefringence of the second retardation film using the Senarmont method. The measurement method shown in FIG. 6 is similar to that shown in FIG. 2 of the above Example 1.

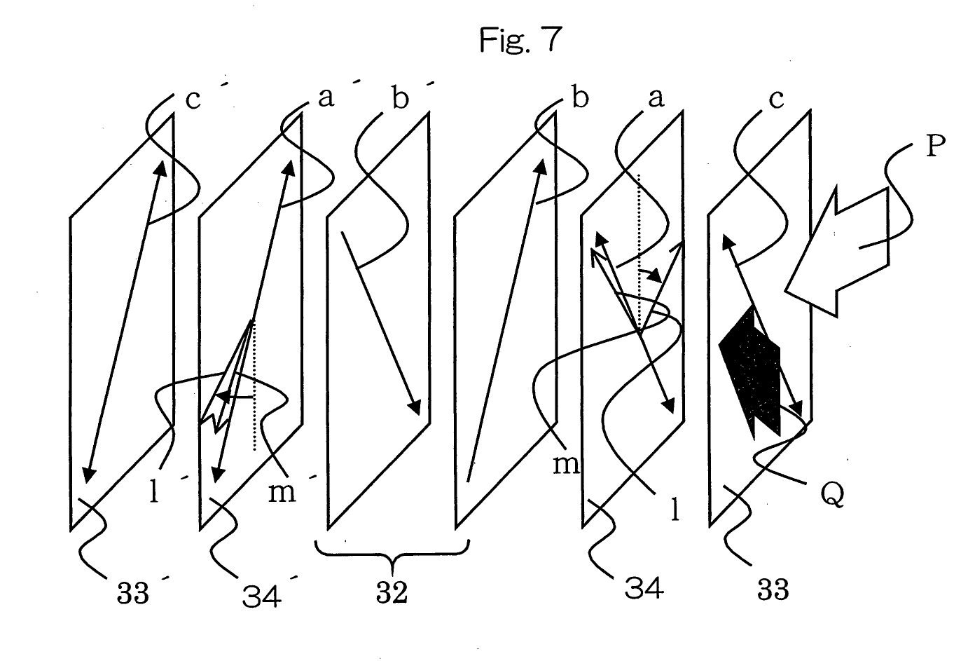

Based on a knowledge about the birefringence of the second retardation film such as an inclination direction of the axis in which a projection profile of the refractive index of the retardation film has a largest size in each of the lateral and vertical directions, and a magnitude of the retardation, the second retardation film in Example 2 and a film having a negative birefringence may be attached together to the liquid crystal display in optical arrangement shown in FIG. 7. In FIG. 7, reference numerals 34 and 34′ denote the second retardation films of the present invention.

If the films are attached to the liquid crystal display as stated above, it is confirmed that wide viewing angle characteristic can be developed without generating a yellowish color in the lateral directions (P direction or Q direction) of the liquid crystal display.

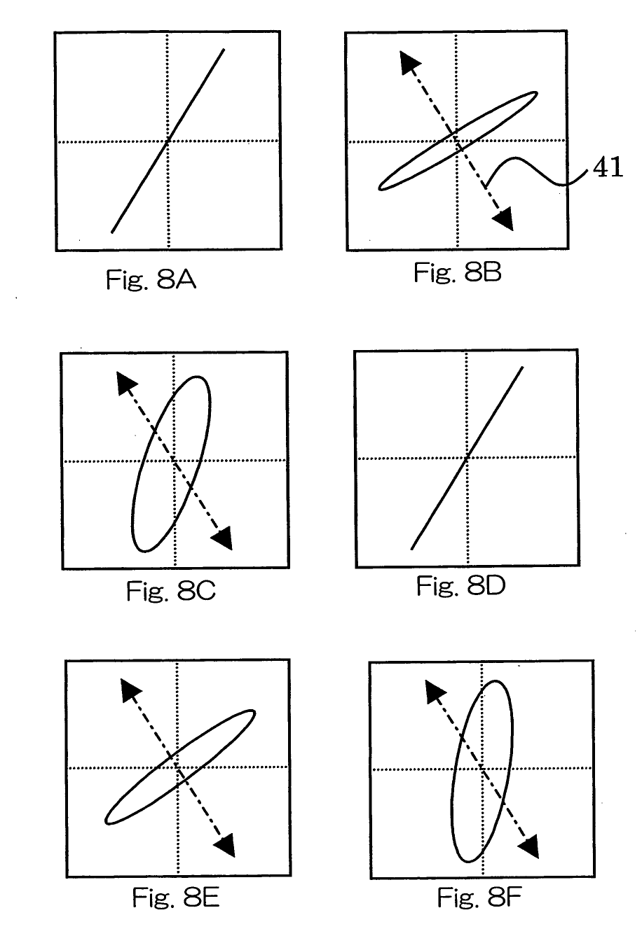

Further, it is confirmed from the simulation results shown in FIGS. 8A to 8F that a good optical compensation effect can be attained when the second retardation films according to the present invention are attached to the liquid crystal display in a transmission light simulation using 4×4 matrix method. Namely, FIGS. 8A to 8F illustrate a simulation of a transmission light when the polarizing plates are provided on a rear side (a back light source side) and a front side (a display surface side) of the cell and the transmission axes of the polarizing plates are set to be perpendicular to each other while each polarizing plate has an angle of rotation of 45°.

FIGS. 8A and 8D illustrate polarized states of a light transmitted through a rear side polarizing plate when the liquid crystal display is viewed from an angle of 55° in the right direction and an angle of 55° in the left direction, respectively. FIGS. 8B and 8E illustrate polarized states of a light incident on the front side polarizing plates when the second retardation film according to the present invention and the negative birefringence film are attached to the liquid crystal display in the optical arrangement shown in FIG. 7, respectively.

As can be seen from FIGS. 8A, 8B, 8D and 8E, the simulation demonstrates that since the light transmitted through the liquid crystal cells from the rear surface of the liquid crystal display is perpendicular to the transmission axis direction of the front side polarizing plate in a state in which the light is relatively close to a linear polarized light, black color display is maintained and the good optical compensation effect can be obtained.

FIGS. 8C and 8F illustrate polarized states of the light incident on the front side polarizing plate when the retardation film and the negative birefringence film are not attached to the liquid crystal display. As can be seen from FIGS. 8C and 8F, when the films are not attached to the liquid crystal display, the polarized state is largely disturbed, the light is not orthogonal to the transmission axis direction of the front side polarizing plate, and the black color display cannot be maintained.

To produce the second retardation film according to the present invention, the same material as that for the first retardation film can be used. Further, the monomer (1) shown by the formula (1), the polymer (1), and the low molecular compound (1) shown by the formula (2) that are synthesized in a similar manner to those in Example 1 can be used.

This material is coated on a transparent substrate to produce this second retardation film. Namely, the substrate is inclined relative to the horizontal plane and irradiated with a light including a perfectly polarized light component and a non-polarized light component from the direction normal to the horizontal plane so that the direction of electric field oscillation of the perfectly polarized light component is not in the direction of the inclined axis and not orthogonal to the inclined axis. The substrate is then heated and cooled to thereby produce the film. In this case, molecules in the film are to be oriented in both directions of electric field oscillation of the perfectly polarized light component and electric field oscillation of P wave of the non-polarized light component. Therefore, it is possible to produce the retardation film according to the present invention characterized by a birefringence bearing a combination of one index ellipsoid having the primary refractive indexes nx in the X axis direction, ny in the Y axis direction and nz in the Z axis direction (where the primary refractive indexes nx, ny, and nz satisfy a relationship of nx>ny≧nz) and another index ellipsoid having primary refractive indexes nx′, ny′, nz′ in a direction in which the one index ellipsoid is rotated at an angle of θ3° about the Y axis as the axis of rotation and at an angle of θ4° about the Z axis as the axis of rotation (where the primary refractive indexes nx′, ny′, and nz′ satisfy a relationship of nx′>ny′≧nz′), if a plane formed by the X and Y axes represents the film surface and the Z axis conforms a direction of the film thickness.

It is noted, however, that the process for producing the retardation film according to the present invention is not limited to the process including light irradiation onto the material that is caused to exhibit a birefringence light irradiation, heating and cooling. As long as the resultant retardation film exhibits the birefringence as stated above, the film may be produced by any arbitrary process such as a process including a conventional different circumferential speed stretching process, a process including orienting liquid crystal molecules on an alignment layer, a process including deposition of an inorganic substance, or such processes combined thereof.

In Example 2, the second retardation film according to the present invention was produced.

### EXAMPLE 2

4.2 w t% of the polymer (1) and 0.8 wt % of the low molecular compound (1) were dissolved in dichloroethane and the mixed solution was coated on a glass substrate (support) in a thickness of about 1 μm. The substrate was inclined at an angle of 60 degrees with respect to the horizontal plane and the substrate was arranged so that a coated surface becomes an irradiated surface. The substrate was irradiated with an ultraviolet ray that consists of a perfectly polarized light component and a non-polarized light component and that has a degree of polarization of 69.4% (where the degree of polarization=perfectly polarized light component/(perfectly polarized light component+non-polarized light component)×100%)) at an intensity of 120 mJ/cm² at room temperature from the direction perpendicular to the horizontal plane after the direction of the electric field oscillation of the perfectly polarized light component is rotated by 15° with respect to the inclined axis of the glass substrate. Next, the substrate was turned upside down and similarly irradiated at an intensity of 120 mJ/cm². Next, the resultant substrate was heated to 100° C. and then cooled to room temperature.

After polarizing plates of a liquid crystal color television EV-510 manufactured by Casio Computer Co., Ltd. were peeled off, two of the second retardation films thus obtained were applied to a liquid crystal cell such that the both were disposed on upper and lower sides of the liquid crystal cell, respectively. Next, a polarizing plate (HEG1425DU, manufactured by Nitto Denko Corporation) was applied to each of the upper and lower sides. The axis of each optical element was arranged as shown in FIG. 7. When the liquid crystal color television having such a structure was driven, no yellowish color was generated in the lateral direction and the viewing angle characteristics were greatly improved. In addition, the viewing angle enlargement effect was recognized in the vertical direction.

### COMPARATIVE EXAMPLE 3

Similarly to Example 2, 4.2 wt % of the polymer (1) and 0.8 wt % of the low molecular weight compound (1) were dissolved in dichloroethane and the mixed solution was coated on a glass substrate (support) in a thickness of about 1 μm. The substrate was inclined at an angle of 60 degrees with respect to the horizontal plane and the substrate was arranged so that a coated surface becomes an irradiated surface. The substrate was irradiated with an ultraviolet ray, which consists of a perfectly polarized light component and a non-polarized light component and that has a degree of polarization of 69.4%, at an intensity of 120 mJ/cm² at room temperature from the direction perpendicular to the horizontal plane so that the direction of the electric field oscillation of the perfectly polarized light component is in parallel to the inclined axis of the glass substrate. Next, the substrate was turned upside down and similarly irradiated at an intensity of 120 mJ/cm². Next, the resultant substrate was heated to 100° C. and then cooled to room temperature to produce a retardation film wherein an biaxial ellipsoid was inclined and the inclined angle dependency of the retardation value of the film with a lagging phase axis set as an inclined axis was asymmetric to the normal direction. After polarizing plates of the liquid crystal color television EV-510 manufactured by Casio Computer Co., Ltd. were peeled off, two of these retardation films were applied to a liquid crystal cell such that the both were disposed on upper and lower sides of the liquid crystal cell, respectively. Next, the polarizing plate (HEG1425DU, manufactured by Nitto Denko Corporation) was applied to each of the upper and lower sides.

When the liquid crystal color television having such a structure was driven, a yellowish color was strongly generated in the lateral direction, i.e., the image degradation occurred.

### COMPARATIVE EXAMPLE 4

Similarly to Example 2, after polarizing plates of the liquid crystal color television EV-510 manufactured by Casio Computer Co., Ltd. were peeled off, two of commercially available optical compensation films having a discotic liquid crystal bent-oriented were applied to a liquid crystal cell such that the both were disposed on upper and lower sides of the liquid crystal cell, respectively. Next, the polarizing plate (HEG1425DU, manufactured by Nitto Denko Corporation) was applied to each of the upper and lower sides.

When the liquid crystal color television having such a structure was driven, a yellowish color was strongly generated in the lateral direction, i.e., the image degradation occurred.

Example 2 demonstrates that it is possible to obtain an optical compensation sheet without generating a yellowish color even in the lateral direction when the retardation film is attached to the liquid crystal display by using the retardation film characterized by a birefringence bearing a combination of one index ellipsoid having the primary refractive indexes nx in the X axis direction, ny in the Y axis direction and nz in the Z axis direction (where the primary refractive indexes nx, ny, and nz satisfy a relationship of nx>ny≧nz) and another index ellipsoid having the primary refractive indexes nx′, ny′, nz′ in the direction in which the one index ellipsoid is rotated at an angle of θ3° about the Y axis as the axis of rotation and at an angle of θ4° about the Z axis as the axis of rotation (where the primary refractive indexes nx′, ny′, and nz′ satisfy a relationship of nx′>ny′≧nz′), if a plane formed by the X and Y axes represents the film surface and the Z axis conforms a direction of the film thickness.

1. A retardation film having a birefringence, wherein
when a first biaxial index ellipsoid having primary refractive indexes nx, ny, and nz is assumed, where the primary refractive indexes nx, ny, and nz in X, Y and Z axis directions, respectively, satisfy a relationship of nx≠ny≠nz, X and Y axes being parallel to a film surface and a Z axis being normal to the film surface, the retardation film has primary refractive indexes nx′, ny′ and nz′ of a biaxial index ellipsoid which is obtained by rotating the first biaxial ellipsoid at an arbitrary rotational angle θ1° about the X axis as an axis of rotation and at an arbitrary rotational angle θ2° about the Y axis as an axis of rotation.

2. A process for producing the retardation film according to claim 1, comprising:
a step of forming a film from a photosensitive material; and
a step of irradiating the film with a light from a direction inclined with respect to the film surface with optional heating and cooling of the film.

3. A retardation film having a birefringence, wherein
the birefringence bears a combination of a first index ellipsoid having primary refractive indexes nx, ny, nz in X,Y and Z axis directions, respectively, X and Y axes being set on the film surface and Z axis conforming a direction of the film thickness, where the primary refractive indexes nx, ny, and nz satisfy a relationship of nx>ny≧nz, and a second index ellipsoid, having primary refractive indexes nx′,ny′, nz′, obtained by rotating the first index ellipsoid at an angle of θ3° about the Y axis as an axis of rotation and at an angle of θ4° about the Z axis as the axis of rotation, where the primary refractive indexes nx′, ny′, and nz′ satisfy a relationship of nx′>ny′≧nz.

4. A process for producing the retardation film according to claim 3, comprising:
a step of forming a film from a photosensitive material; and
a step of irradiating the film with a light from a direction inclined with respect to the film surface with optional heating and cooling of the film.

5. The process for producing the retardation film according to claim 4, wherein the light irradiated from the direction inclined with respect to the film surface includes a perfectly polarized light component and a non-polarized light component and a direction of electric field oscillation of said perfectly polarized light component is non-parallel and non-orthogonal to a plane of incidence of the irradiated light.
